(19) United States
(12) Patent Application Publication
(10) Pub. No.: US 2023/0375096 A1
(43) Pub. Date: Nov. 23, 2023

(54) MULTI-CONTROL VALVE

(71) Applicant: KAWASAKI JUKOGYO KABUSHIKI KAISHA, Kobe-shi, Hyogo (JP)

(72) Inventors: Seiji AOKI, Kobe-shi (JP); Yoshiyuki TODE, Kobe-shi (JP); Koji YAMASAKI, Kobe-shi (JP)

(73) Assignee: KAWASAKI JUKOGYO KABUSHIKI KAISHA, Kobe-shi, Hyogo (JP)

(21) Appl. No.: 18/031,397

(22) PCT Filed: Sep. 10, 2021
(86) PCT No.: PCT/JP2021/033358

§ 371 Date: Apr. 12, 2023

(30) Foreign Application Priority Data
Nov. 17, 2020 (JP) 2020-191038

(51) Int. Cl. F16K 11/22; F16K 27/04

(52) U.S. Cl. CPC F16K 11/22; F16K 27/041; E02F 9/2267

(57) ABSTRACT

A multi-control valve includes: spools that are located side by side in a particular direction; and a housing including slide holes that receive therein the respective spools. The housing includes a first and second pump passages that extend in the particular direction, the first and second pump passages being located at both sides of the spools, respectively. Among the spools, a common spool that is used in common for the first and second pump passages is received in a merging slide hole. The housing includes: a first communication passage that is located at the first pump passage side of the merging slide hole and that extends from the first pump passage to the merging slide hole; and a second communication passage that is located at the second pump passage side of the merging slide hole and that extends from the second pump passage to the merging slide hole.

### TECHNICAL FIELD

The present disclosure relates to a multi-control valve including multiple spools.

### BACKGROUND ART

Conventionally, in a construction machine such as a hydraulic excavator or a hydraulic crane, a multi-control valve is used in a hydraulic circuit for driving the construction machine. In the multi-control valve, multiple spools are slidably held by a housing. Each spool is intended for controlling the moving direction and the moving speed of a corresponding hydraulic actuator.

In the hydraulic circuit of the construction machine, there is a case where two pumps are used for supplying a large amount of hydraulic oil to a particular hydraulic actuator. In this case, generally speaking, the multi-control valve is configured such that the hydraulic oil delivered from one of the pumps and the hydraulic oil delivered from the other pump merge together at a position downstream of two spools corresponding to the respective two pumps.

In recent years, there has also been proposed a multi-control valve in which one spool is used for two pumps, and flows of hydraulic oil delivered from the respective two pumps are merged at a position upstream of the spool. For example, Patent Literature 1 discloses a multi-control valve 100 as shown in FIG. 6.

Specifically, the multi-control valve 100 includes: spools 120 (in FIG. 6, only one of the spools 120 is shown), which are located side by side in a direction perpendicular to the plane of FIG. 6; and a housing 110 including slide holes 111 (in FIG. 6, only one of the slide holes 111 is shown), which receive therein the respective spools 120.

The housing 110 includes: a first center bypass passage 101 and a first pump passage 103, through which hydraulic oil delivered from a first pump flows; and a second center bypass passage 102 and a second pump passage 104, through which hydraulic oil delivered from a second pump flows.

The first center bypass passage 101 is a passage that is branched off from the first pump passage 103 and then extends to pass through all the spools 120. The first center bypass passage 101 is opened when all the spools 120 are in their neutral positions, and is closed when any of the spools 120 shifts from its neutral position. Specifically, the first center bypass passage 101 is configured by utilizing part of the slide holes 111 at positions where the spools are present, and there are shifts in the first center bypass passage 101 in the axial directions of the respective spools 120, such that the first center bypass passage 101 is in the shape of pulses. The widths of the pukes are the same as the pitches between the spools 120. Meanwhile, at one side of the spools 120, the first pump passage 103 extends in the direction in which the spools 120 are located side by side.

Similarly, the second center bypass passage 102 is a passage that is branched off from the second pump passage 104 and then extends to pass through all the spools 120. The second center bypass passage 102 is opened when all the spools 120 are in their neutral positions, and is closed when any of the spools 120 shifts from its neutral position. Specifically, the second center bypass passage 102 is configured by utilizing part of the slide holes 111 at positions where the spools are present, and there are shifts in the second center bypass passage 102 in the axial directions of the respective spools 120, such that the second center bypass passage 102 is in the shape of pulses. The widths of the pulses are the same as the pitches between the spools 120. Meanwhile, the second pump passage 104 extends in parallel with the first pump passage 103 in the direction in which the spools 120 are located side by side.

The housing 110 further includes: a bridge passage 112, which surrounds the first pump passage 103 and the second pump passage 104 together with the slide hole 111; a first communication hole 105, through which the first pump passage 103 communicates with the bridge passage 112; and a second communication hole 106, through which the second pump passage 104 communicates with the bridge passage 112.

In the example shown in FIG. 6, a unidirectional restrictor valve 130 is located in the first communication hole 105, and a blind plug 140 is located in the second communication hole 106. It is described in Patent Literature 1 that pressure regulators may be used instead of the unidirectional restrictor valve 130 and the blind plug 140. In this case, the hydraulic oil supplied from the first pump passage 103 (i.e., the hydraulic oil delivered from the first pump) and the hydraulic oil supplied from the second pump passage 104 (i.e., the hydraulic oil delivered from the second pump) merge together in the bridge passage 112.

### CITATION LIST

### Patent Literature

PTL 1: Japanese National Phase PCT Laid-Open Application Publication No. 2007-501914

### SUMMARY OF INVENTION

### Technical Problem

However, in the above-described configuration in which flows of hydraulic oil merge together in the bridge passage 112, the hydraulic oil supplied from one pump passage passes through a pressure regulating valve installed for the other pump passage. This results in great pressure loss.

In view of the above, an object of the present disclosure is to provide a multi-control valve that makes it possible to reduce pressure loss when one spool is used for two pumps.

### Solution to Problem

In order to solve the above-described problems, a multi-control valve according to the present disclosure includes: spools that are located side by side in a particular direction; and a housing including slide holes that receive therein the respective spools, the housing including a first pump passage and a second pump passage that extend in the particular direction, the first pump passage and the second pump passage being located at both sides of the spools, respectively. The spools include a common spool that is used in common for the first pump passage and the second pump passage. The slide holes include a merging slide hole that receives therein the common spool. The housing includes: a first communication passage that is located at the first pump passage side of the merging slide hole and that extends from the first pump passage to the merging slide hole; and a second communication passage that is located at the second pump passage side of the merging slide hole and that extends from the second pump passage to the merging slide hole.

According to the above configuration, the hydraulic oil supplied from the first pump passage and the hydraulic oil supplied from the second pump passage merge together in the merging slide hole. Therefore, even if there is a valve on each of the first communication passage and the second communication passage, pressure loss can be reduced compared to the conventional art.

### Advantageous Effects of Invention

The present disclosure provides a multi-control valve that makes it possible to reduce pressure loss when one spool is used for two pumps.

### BRIEF DESCRIPTION OF DRAWINGS

FIG. 1 shows a multi-control valve according to one embodiment of the present disclosure as seen in the axial direction of spools.

FIG. 2 is a sectional view taken along line II-II of FIG. 1.

FIG. 3 is a sectional view taken along line III-III of FIG. 1.

FIG. 4 is a sectional view taken along line IV-IV of FIG. 1.

FIG. 5 is a sectional view of a variation of the multi-control valve.

FIG. 6 is a sectional view of a conventional multi-control valve.

### DESCRIPTION OF EMBODIMENTS

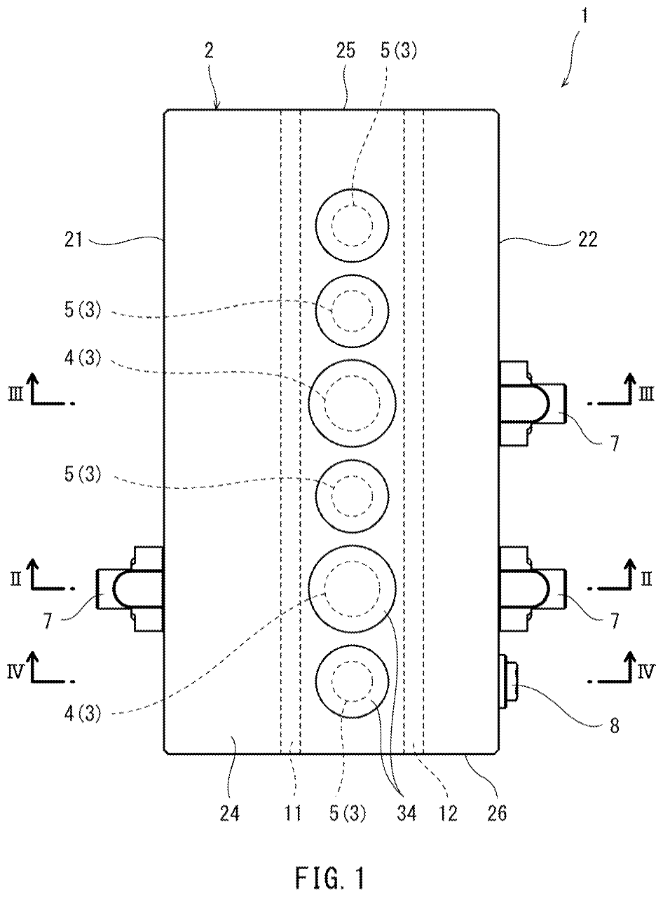

FIGS. 1 to 4 show a multi-control valve 1 according to one embodiment of the present disclosure. The multi-control valve 1 includes: spools 3, which are parallel to each other and located side by side in a line in a particular direction (in FIG. 1, the vertical direction); and a housing 2, which slidably holds these spools 3. In the illustrated example, the number of spools 3 is six. However, the number of spools 3 is modifiable as necessary.

Although not illustrated, the housing 2 may slidably hold one or more spools that is/are different from the spools 3 and positioned not on an arrangement plane of the spools 3 (i.e., a plane that is defined by the side-by-side arrangement direction of the spools 3 and the axial direction of the spools 3). In a case where the number of these different spools is plural, the different spools may be located side by side in a line at a position lateral to the spools 3.

The housing 2 has a rectangular parallelepiped shape that extends in the side-by-side arrangement direction of the spools 3. The housing 2 includes: a pair of end surfaces 25 and 26 orthogonal to the side-by-side arrangement direction of the spools 3; a first side surface 21 and a second side surface 22 parallel to the arrangement plane of the spools 3; and a third side surface 23 and a fourth side surface 24, which are orthogonal to the axial direction of the spools 3. That is, the end surfaces 25 and 26 face away from each other in the side-by-side arrangement direction of the spools 3; the first side surface 21 and the second side surface 22 face away from each other in a direction orthogonal to the arrangement plane of the spools 3; and the third side surface 23 and the fourth side surface 24 face away from each other in the axial direction of the spools 3.

The housing 2 includes slide holes 20; which receive therein the respective spools 3. Each slide hole 20 penetrates the housing 2, and is open on the third side surface 23 and the fourth side surface 24. The opening of each slide hole 20 on the third side surface 23 is covered by a plate-shaped first cover 32, and the opening of each slide hole 20 on the fourth side surface 24 is covered by a container-shaped second cover 34.

However, the configuration of the multi-control valve 1 is modifiable as necessary. For example, a block that covers the openings of all the slide holes 20 on the third side surface 23 may be used instead of the first covers 32, and a block that covers the openings of all the slide holes 20 on the fourth side surface 24 may be used instead of the second covers 34.

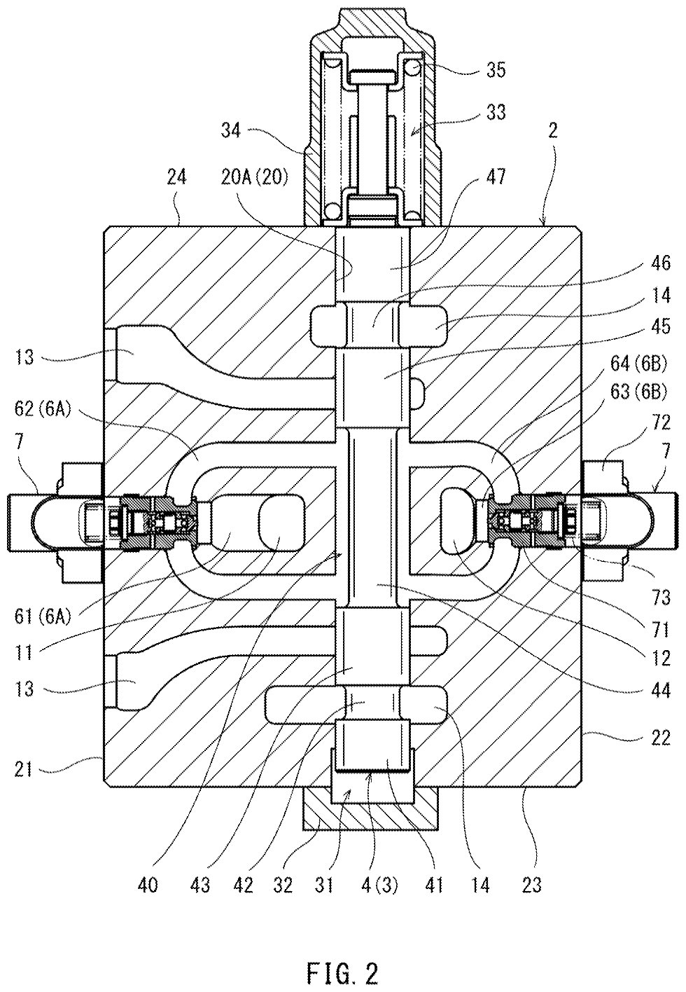

In the present embodiment, each spool 3 is moved by a pilot pressure. Accordingly, each first cover 32 forms a first pilot chamber 31 between the first cover 32 and one end surface of the corresponding spool 3, and each second cover 34 forms a second pilot chamber 33 between the second cover 34 and the other end surface of the corresponding spool 3. The first pilot chamber 31 is a chamber into which a pilot pressure for shifting the spool 3 to one side in the axial direction (in FIGS. 2 to 4, upward) is introduced. The second pilot chamber 33 is a chamber into which a pilot pressure for shifting the spool 3 to the other side in the axial direction (in FIGS. 2 to 4; downward) is introduced.

Each spool 3 need not be moved by a pilot pressure. For example, each spool 3 may be shifted by an electric actuator that includes an electric motor and a linear motion mechanism.

In the second cover 34, there is a spring 35 to keep the spool 3 in its neutral position. The spring 35 urges the spool 3 to return to the neutral position both when the spool 3 has shifted to one side in the axial direction and when the spool 3 has shifted to the other side in the axial direction. Since this structure is known, a detailed description thereof is omitted herein.

The housing 2 includes: a first pump passage 11, which is located between the first side surface 21 and the spools 3 and which extends in the side-by-side arrangement direction (the aforementioned particular direction) of the spools 3; and a second pump passage 12, which is located between the second side surface 22 and the spools 3 and which extends in the side-by-side arrangement direction of the spools 3. In other words, the first pump passage 11 and the second pump passage 12 are located at both sides of the spools 3, respectively.

The first pump passage 11 penetrates the housing 2, and is open on the end surfaces 25 and 26. One of the openings of the first pump passage 11 is sealed by an unshown plug, and an unshown first pump is connected to the other opening by a pipe. Similarly, the second pump passage 12 penetrates the housing 2, and is open on the end surfaces 25 and 26. One of the openings of the second pump passage 12 is sealed by an unshown plug, and an unshown second pump is connected to the other opening by a pipe.

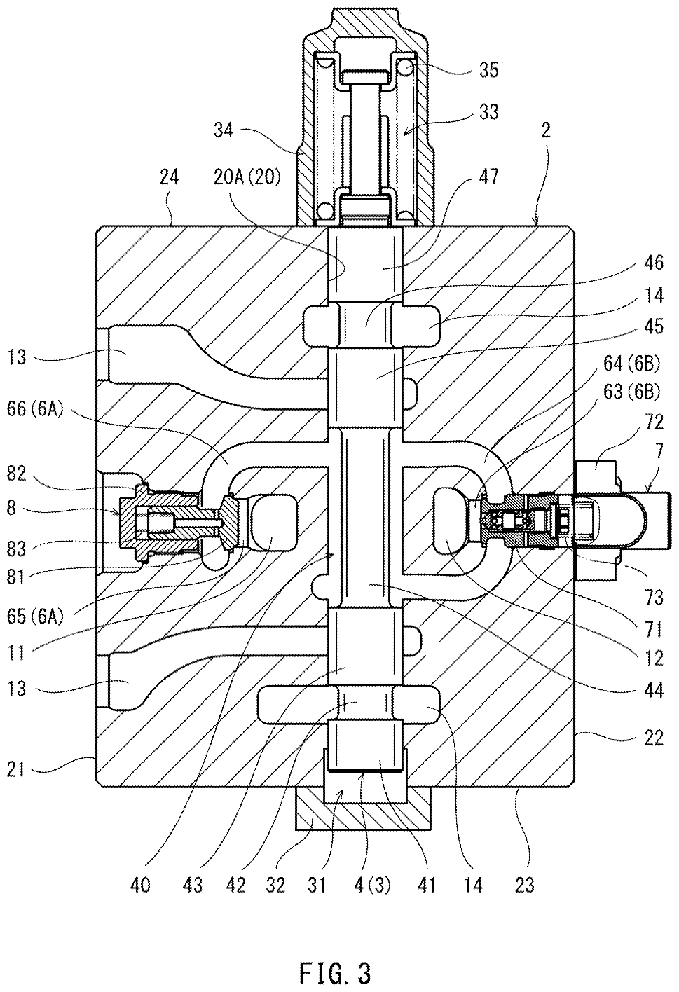

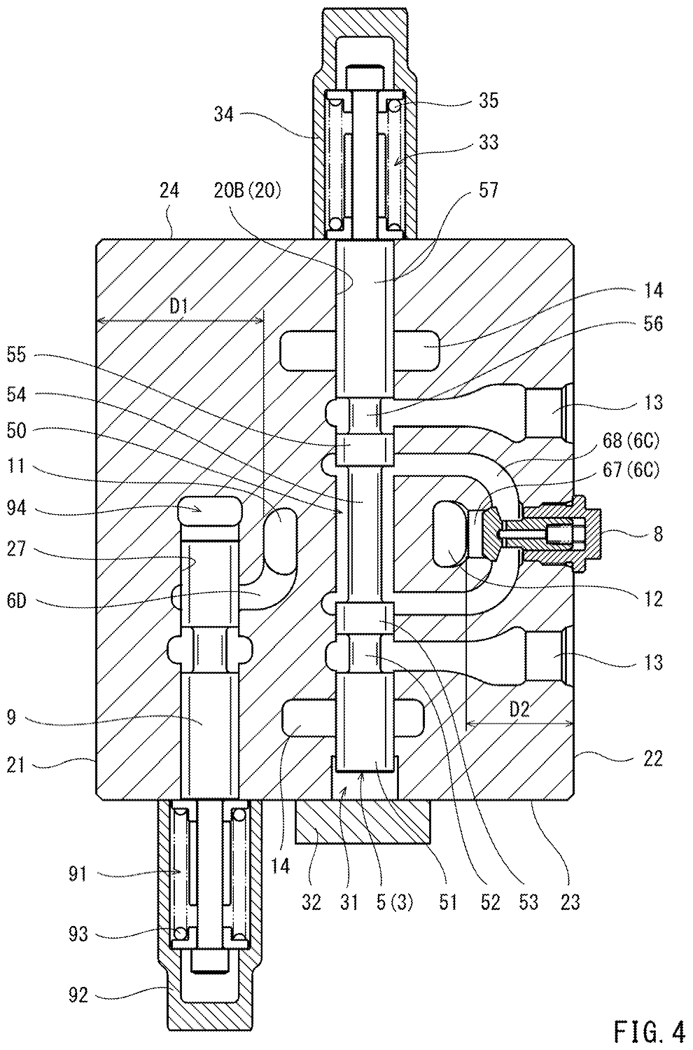

In the present embodiment, the spools 3 include two common spools 4 and four normal spools 5. As shown in FIG. 2 and FIG. 3, the two common spools 4 are used in common for the first pump passage 11 and the second pump passage 12. As shown in FIG. 4, the four normal spools 5 are used for one of the first pump passage 11 or the second pump passage 12 (in FIG. 4, used for the second pump passage 12). The number of common spools 4 and the number of normal spools 5 are modifiable as necessary. The spools 3 may include only the common spools 4.

The maximum diameter of each common spool 4 (i.e., the diameter of lands 43 and 45 described below) is greater than the maximum diameter of each normal spool 5 (i.e., the diameter of lands 53 and 55 described below). The flow rate of hydraulic oil flowing through the common spools 4 is higher than the flow rate of hydraulic oil flowing through the normal spools 5. Accordingly, by setting the maximum diameter of each common spool 4 to be greater than the maximum diameter of each normal spool 5, the common spools 4 can be made suitable for high flow rates.

The housing 2 includes, for each spool 3, a pair of supply/discharge passages 13. The supply/discharge passages 13 are open on the first side surface 21 or the second side surface 22, An unshown bi-directionally movable hydraulic actuator (a hydraulic cylinder or a hydraulic motor) is connected to these openings by pipes.

Each common spool 4 makes it possible to supply the hydraulic oil from both the first pump passage 11 and the second pump passage 12 to one of the supply/discharge passages 13. Each normal spool 5 makes it possible to supply the hydraulic oil from the first pump passage 11 or the second pump passage 12 to one of the supply/discharge passages 13.

The housing 2 further includes a tank passage 14. The tank passage 14 is open on any one of the following surfaces: the end surfaces 25, 26, and the first to fourth side surfaces 21 to 24. An unshown tank is connected to the opening of the tank passage 14 by a pipe.

First, with reference to FIG. 2, the surrounding structure of one common spool 4 (the second spool 3 counted from the bottom of FIG. 1) is described. The common spool 4 is received in a merging slide hole 20A, which is one of the slide holes 20.

The housing 2 includes a first communication passage 6A, which is located at the first pump passage 11 side of the merging slide hole 20A, i.e., located between the first side surface 21 and the merging slide hole 20A, and which extends from the first pump passage 11 to the merging slide hole 20A. Similarly, the housing 2 includes a second communication passage 6B, which is located at the second pump passage 12 side of the merging slide hole 20A, i.e., located between the second side surface 22 and the merging slide hole 20A, and which extends from the second pump passage 12 to the merging slide hole 20A. In FIG. 2, the pair of supply/discharge passages 13 are located at both sides of the first communication passage 6A, respectively. Alternatively, the pair of supply/discharge passages 13 may be located at both sides of the second communication passage 6B, respectively.

To be more specific, the first communication passage 6A includes: a bridge passage 62, which surrounds the first pump passage 11 together with the merging slide hole 20A; and a communication hole 61, through which the first pump passage 11 communicates with the bridge passage 62. The communication hole 61 extends from the first pump passage 11 in a direction away from the merging slide hole 20A.

Similarly, the second communication passage 613 includes: a bridge passage 64, which surrounds the second pump passage 12 together with the merging slide hole 20A; and a communication hole 63, through which the second pump passage 12 communicates with the bridge passage 64. The communication hole 63 extends from the second pump passage 12 in a direction away from the merging slide hole 20A.

Both ends of the bridge passage 62 are connected to the merging slide hole 20A, and the above-described pair of supply/discharge passages 13 are connected to the merging slide hole 20A at the outer sides of both ends of the bridge passage 62, respectively. Further, at the outer sides of the pair of supply/discharge passages 13, the tank passage 14 is connected to the merging slide hole 20A.

The common spool 4 includes: a pair of lands 43 and 45, which opens and closes the supply/discharge passages 13; and a middle smaller-diameter portion 44, which couples the pair of lands 43 and 45 to each other. The common spool 4 further includes: one end portion 41 and other end portion 47, which have the same diameter as that of the lands 43 and 45; a one-end-side smaller-diameter portion 42, which couples the one end portion 41 to the land 43; and an other-end-side smaller-diameter portion 46, which couples the other end portion 47 to the land 45.

Both ends of the bridge passage 62 and both ends of the bridge passage 64 communicate with an annular passage 40 between the inner peripheral surface of the merging slide hole 20A and the middle smaller-diameter portion 44.

When the common spool 4 is in the neutral position shown in FIG. 2, the pair of supply/discharge passages 13 is closed by the lands 43 and 45. When the common spool 4 shifts from the neutral position to one side in the axial direction (in FIG. 2, upward), the land 45 opens one of the supply/discharge passages 13 in FIG. 2, the upper supply/discharge passage 13), such that the one supply/discharge passage 13 comes into communication with the first pump passage 11 through the annular passage 40 and the first communication passage 6A and with the second pump passage 12 through the annular passage 40 and the second communication passage 6B. Concurrently, the land 43 opens the other supply/discharge passage 13 (in FIG. 2, the lower supply/discharge passage 13), such that the other supply/discharge passage 13 comes into communication with the tank passage 14 through the annular passage between the inner peripheral surface of the merging slide hole 20A and the one-end-side smaller-diameter portion 42.

On the other hand, when the common spool 4 shifts from the neutral position to the other side in the axial direction (in FIG. 2, downward), the land 43 opens one of the supply/discharge passages 13 (in FIG. 2, the lower supply/discharge passage 13), such that the one supply/discharge passage 13 conies into communication with the first pump passage 11 through the annular passage 40 and the first communication passage 6A and with the second pump passage 12 through the annular passage 40 and the second communication passage 6B, Concurrently, the land 45 opens the other supply/discharge passage 13 (in FIG. 2, the upper supply/discharge passage 13), such that the other supply/discharge passage 13 comes into communication with the tank passage 14 through the annular passage between the inner peripheral surface of the merging slide hole 20A and the other-end-side smaller-diameter portion 46.

In FIG. 2, a logic valve 7 is located on each of the first communication passage 6A and the second communication passage 6B. The logic valve 7 located on the first communication passage 6A opens and closes the opening, of the communication hole 61, to the bridge passage 62. The logic valve 7 located on the second communication passage 6B opens and closes the opening, of the communication hole 63, to the bridge passage 64.

These logic valves 7 are the same in configuration. Each logic valve 7 allows a flow from the first pump passage 11 or the second pump passage 12 toward the merging slide hole 20A, but prevents the reverse flow. The opening degree of each logic valve 7 when allowing the flow from the first pump passage 11 or the second pump passage 12 toward the merging slide hole 20A is changeable. The logic valve 7 may be a pilot valve whose opening degree is changeable by a pilot pressure, or may be a solenoid valve whose opening degree is changeable by an electrical signal.

Specifically, each logic valve 7 includes: a valve body 71, which is slidably held by the housing 2; a control unit 72 mounted to the first side surface 21 or the second side surface 22; and a spring 73 located between the valve body 71 and the control unit 72. Since the structure of the logic valve 7 is known, a further detailed description thereof is omitted herein.

The surrounding structure of another common spool 4 shown in FIG. 3 (the third spool 3 counted from the top of FIG. 1) is different from the surrounding structure of the common spool 4 shown in FIG. 2 only in terms of the configuration of the first communication passage 6A. Specifically, in FIG. 3, the first communication passage 6A includes: an L-shaped passage 66; and a communication hole 65, through which the first pump passage 11 communicates with the L-shaped passage 66. In FIG. 3, the pair of supply/discharge passages 13 are located at both sides of the first communication passage 6A, respectively. Alternatively, the pair of supply/discharge passages 13 may be located at both sides of the second communication passage 6B, respectively.

The L-shaped passage 66 includes: a parallel portion that is positioned at the opposite side of the first pump passage 11 from the merging slide hole 20A and that is parallel to the axial direction of the common spool 4; and a perpendicular portion that connects one end of the parallel portion to the merging slide hole 20A and that is perpendicular to the axial direction of the common spool 4. The communication hole 65 extends from the first pump passage 11 in a direction away from the merging slide hole 20A.

Further, in FIG. 3, a load check valve 8 is located on the first communication passage 6A. The load check valve 8 opens and closes an opening, of the communication hole 65, to the L-shaped passage 66. The load check valve 8 allows a flow from the first pump passage 11 to the merging slide hole 20A, but prevents the reverse flow.

Specifically, the load check valve 8 includes: a main structure 82 fixed to the housing 2; a valve body 81 slidably held by the main structure 82; and a spring 83 located between the main structure 82 and the valve body 81. Since the structure of the load check valve 8 is known, a further detailed description thereof is omitted herein.

Lastly, with reference to FIG. 4, the surrounding structure of one normal spool 5 (the bottom spool 3 in FIG. 1) is described. A description of the surrounding structure of each of the other normal spools 5 is omitted herein. The surrounding structure of each of the other normal spools 5 is the same as, or similar to, the structure shown in FIG. 4.

The normal spool 5 is received in a normal slide hole 20B, which is one of the slide holes 20. In FIG. 4, the housing 2 includes, at the second pump passage 12 side of the normal slide hole 20B, i.e., between the second side surface 22 and the normal slide hole 20B, a communication passage 6C, which extends from the second pump passage 12 to the normal slide hole 20B. In FIG. 4, the pair of supply/discharge passages 13 are located at both sides of the first communication passage 6C, respectively.

To be more specific, the communication passage 6C includes: a bridge passage 68, which surrounds the second pump passage 12 together with the normal slide hole 20B; and a communication hole 67, through which the second pump passage 12 communicates with the bridge passage 68. The communication hole 67 extends from the second pump passage 12 in a direction away from the normal slide hole 20B.

Both ends of the bridge passage 68 are connected to the normal slide hole 20B, and the aforementioned pair of supply/discharge passages 13 are connected to the normal slide hole 20B at the outer sides of both ends of the bridge passage 68, respectively. Further, at the outer sides of the pair of supply/discharge passages 13, the tank passage 14 is connected to the normal slide hole 20B.

The normal spool 5 includes: a pair of lands 53 and 55, which opens and closes the supply/discharge passages 13; and a middle smaller-diameter portion 54, which couples the pair of lands 53 and 55 to each other. The normal spool 5 further includes: one end portion 51 and other end portion 57, which have the same diameter as that of the lands 53 and 55; a one-end-side smaller-diameter portion 52, which couples the one end portion 51 to the land 53; and an other-end-side smaller-diameter portion 56, which couples the other end portion 57 to the land 55.

Both ends of the bridge passage 68 communicate with an annular passage 50 between the inner peripheral surface of the normal slide hole 20B and the middle smaller-diameter portion 54.

When the normal spool 5 is in the neutral position shown in FIG. 4, the pair of supply/discharge passages 13 is closed by the lands 53 and 55. When the normal spool 5 shifts from the neutral position to one side in the axial direction (in FIG. 4, upward), the land 55 opens one of the supply/discharge passages 13 (in FIG. 4, the upper supply/discharge passage 13), such that the one supply/discharge passage 13 comes into communication with the second pump passage 12 through the annular passage 50 and the communication passage 6C. Concurrently, the land 53 opens the other supply/discharge passages 13 (in FIG. 4, the lower supply/discharge passage 13), such that the other supply/discharge passage 13 comes into communication with the tank passage 14 through the annular passage between the inner peripheral surface of the normal slide hole 20B and the one-end-side smaller-diameter portion 52.

On the other hand, when the normal spool 5 shifts from the neutral position to the other side in the axial direction (in FIG. 4, downward), the land 53 opens one of the supply/discharge passages 13 (in FIG. 4, the lower supply/discharge passage 13), such that the one supply/discharge passage 13 comes into communication with the second pump passage 12 through the annular passage 50 and the communication passage 6C, Concurrently, the land 55 opens the other supply/discharge passage 13 (in FIG. 4, the upper supply/discharge passage 13), such that the other supply/discharge passage 13 comes into communication with the tank passage 14 through the annular passage between the inner peripheral surface of the normal slide hole 20B and the other-end-side smaller-diameter portion 56.

In FIG. 4, the load check valve 8 is located on the communication passage 6C. The load check valve 8 opens and closes an opening, of the communication hole 67, to the bridge passage 68. The load check valve 8 allow a flow from the second pump passage 12 to the normal slide hole 20B, but prevents the reverse flow.

As shown in FIG. 4, a distance D1 from the first side surface 21 to the first pump passage 11 is greater than a distance D2 from the second side surface 22 to the second pump passage 12. According to this configuration, a space between the first side surface 21 and the first pump passage 11 can be utilized for the installation of another device.

In FIG. 4, the housing 2 includes a slide hole 27 located between the first side surface 21 and the first pump passage 11. The slide hole 27 receives therein a spool 9 different from the spool 3. The housing 2 further includes a communication passage 6D, which extends from the first pump passage 11 to the slide hole 27. The slide hole 27 is open on the third side surface 23, and the opening of the slide hole 27 is covered by a container-shaped cover 92.

The spool 9 is moved by a pilot pressure. Accordingly, the cover 92 forms a first pilot chamber 91 between the cover 92 and one end surface of the spool 9. The first pilot chamber 91 is a chamber into which a pilot pressure for shifting the spool 9 to one side in the axial direction (in FIG. 4, upward) is introduced. The length of the spool 9 is about a half of the length of the spool 3. The housing 2 includes a second pilot chamber 94, into which a pilot pressure for shifting the spool 9 to the other side in the axial direction (in FIG. 4, downward) is introduced. In the cover 92, similar to the spools 3, there is a spring 93 to keep the spool 9 in its neutral position.

In the multi-control valve 1 configured as described above, when the common spool 4 moves, the hydraulic oil supplied from the first pump passage 11 and the hydraulic oil supplied from the second pump passage 12 merge together in the merging slide hole 20A. Therefore, even if there is a valve, such as the logic valve 7 or the load check valve 8, on each of the first communication passage 6A and the second communication passage 6B, pressure loss can be reduced compared to the conventional art.

In addition, as shown in FIG. 2 and FIG. 3, in a case where the logic valve 7 is located on at least one of the first communication passage 6A or the second communication passage 6B, the ratio between the flow rate of the hydraulic oil supplied from the first pump passage 11 and the flow rate of the hydraulic oil supplied from the second pump passage 12 when the hydraulic oil supplied from the first pump passage 11 and the hydraulic oil supplied from the second pump passage 12 merge together can be adjusted.

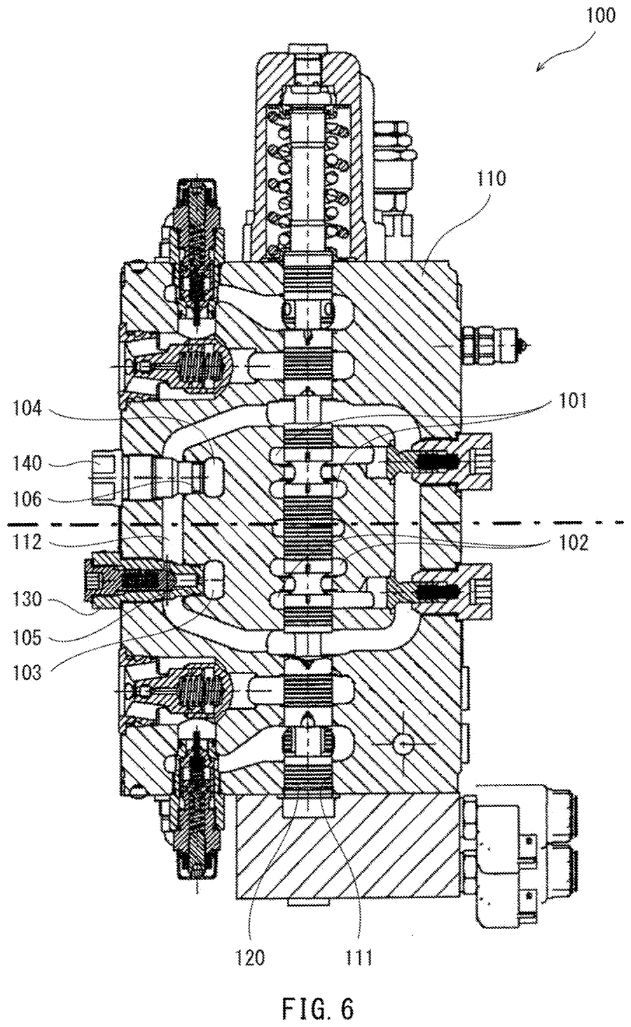

Incidentally, in the conventional multi-control valve 100 shown in FIG. 6, since the first pump passage 103 and the second pump passage 104 are located side by side in the axial direction of the spool 120, the dimension of the housing 110 in the axial direction of the spool 120 is great. On the other hand, in the multi-control valve 1 of the present embodiment, since the first pump passage 11 and the second pump passage 12 are located at both sides of the spool 3, respectively, the dimension of the housing 2 in the axial direction of the spool 3 can be reduced.

### Variations

The present disclosure is not limited to the above-described embodiment. Various modifications can be made without departing from the scope of the present disclosure.

For example, although not illustrated, instead of the middle smaller-diameter portion 44, the common spool 4 may adopt a middle land and smaller-diameter portions that are located at both sides of the middle land, respectively. However, in a case where the common spool 4 adopts the middle smaller-diameter portion 44 as in the above-described embodiment, such a configuration allows the hydraulic oil from the communication hole (61 or 63) to flow into the bridge passage (62 or 64) toward both sides of the bridge passage (62 or 64). Therefore, pressure loss can be reduced compared to a case where the common spool 4 includes the middle land.

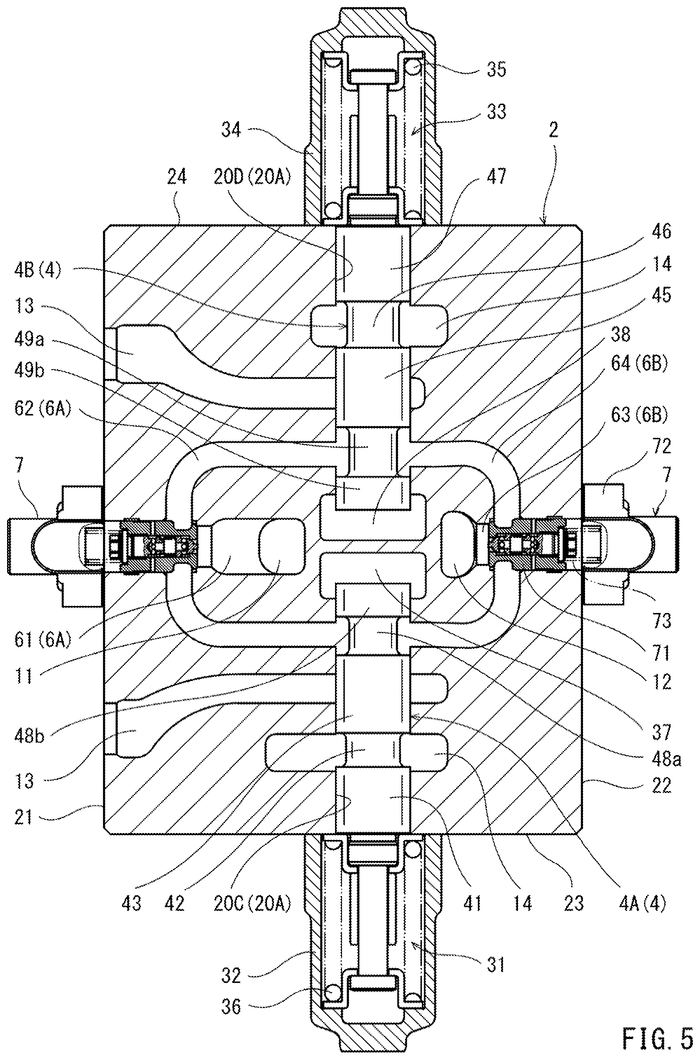

Each common spool 4 need not be a single spool. For example, as shown in FIG. 5, the common spool 4 may be divided into a first spool 4A and a second spool 4B. The first spool 4A includes the land 43, which opens and closes one of the supply/discharge passages 13. The second spool 4B includes the land 45, which opens and closes the other supply/discharge passage 13. In the case of adopting this configuration, meter-in control and meter-out control can be performed independently of each other.

In a case where the common spool 4 includes the first spool 4A and the second spool 4B located coaxially with each other as shown in FIG. 5, the configuration in which the first pump passage 11 and the second pump passage 12 are located at both sides, respectively, of a region between the first spool 4A and the second spool 4B is one example of the configuration in which the first pump passage 11 and the second pump passage 12 are located at both sides of the common spool 4, respectively.

To be more specific, in the variation shown in FIG. 5, the merging slide hole 20A does not penetrate the housing 2, but includes two bottomed holes 20C and 20D located coaxially with each other. The bottomed hole 20C, which is open on the third side surface 23, receives the first spool 4A therein. The bottomed hole 20D, which is open on the fourth side surface 24, receives the second spool 4B therein.

Also, in the variation shown in FIG. 5, the first cover 32 is container-shaped, and there is the first pilot chamber 31 between the first cover 32 and one end surface of the first spool 4A. In the first cover 32, there is a spring 36 to keep the first spool 4A in its neutral position. On the other hand, the spring 35 in the second cover 34 serves to keep the second spool 4B in its neutral position.

There is a third pilot chamber 37 between the other end surface of the first spool 4A and the bottom of the bottomed hole 20C, and there is a fourth pilot chamber 38 between one end surface of the second spool 413 and the bottom of the bottomed hole 20D.

The first spool 4A includes the one end portion 41, the one-end-side smaller-diameter portion 42, and the land 43, which have been described in the above embodiment, and further includes an other end portion 48b, whose diameter is the same as that of the land 43, and an other-end-side smaller-diameter portion 48a, which couples the other end portion 48b to the land 43. Similarly, the second spool 4B includes the other end portion 47, the other-end-side smaller-diameter portion 46, and the land 45, which have been described in the above embodiment, and further includes one end portion 49b, whose diameter is the same as that of the land 45, and a one-end-side smaller-diameter portion 49a, which couples the one end portion 49b to the land 45.

In FIG. 3 and FIG. 5, the logic valve 7 is located on each of the first communication passage 6A and the second communication passage 613. Alternatively, instead of the logic valve 7, the load check valve 8 may be located on the first communication passage 6A and/or the second communication passage 613.

### SUMMARY

A multi-control valve according to the present disclosure includes: spools that are located side by side in a particular direction; and a housing including slide holes that receive therein the respective spools, the housing including a first pump passage and a second pump passage that extend in the particular direction, the first pump passage and the second pump passage being located at both sides of the spools, respectively. The spools include a common spool that is used in common for the first pump passage and the second pump passage. The slide holes include a merging slide hole that receives therein the common spool. The housing includes: a first communication passage that is located at the first pump passage side of the merging slide hole and that extends from the first pump passage to the merging slide hole; and a second communication passage that is located at the second pump passage side of the merging slide hole and that extends from the second pump passage to the merging slide hole.

According to the above configuration, the hydraulic oil supplied from the first pump passage and the hydraulic oil supplied from the second pump passage merge together in the merging slide hole. Therefore, even if there is a valve on each of the first communication passage and the second communication passage, pressure loss can be reduced compared to the conventional art.

The housing may include a pair of supply/discharge passages that are located at both sides, respectively, of the first communication passage or the second communication passage. The common spool may include: a pair of lands that opens and closes the pair of supply/discharge passages; and a smaller-diameter portion that couples the pair of lands to each other. At least one of the first communication passage or the second communication passage may include: a bridge passage whose both ends communicate with an annular passage between an inner peripheral surface of the merging slide hole and the smaller-diameter portion; and a communication hole, through which the first pump passage or the second pump passage communicates with the bridge passage. This configuration allows the hydraulic oil from the communication hole to flow into the bridge passage toward both sides of the bridge passage. Therefore, pressure loss can be reduced compared to a case where the common spool includes a middle land.

Alternatively, the housing may include a pair of supply/discharge passages that are located at both sides, respectively, of the first communication passage or the second communication passage. The common spool may be divided into: a first spool including a land that opens and closes one of the pair of supply/discharge passages; and a second spool including a land that opens and closes the other one of the pair of supply/discharge passages. According to this configuration, meter-in control and meter-out control can be performed independently of each other.

For example, the spools may include a normal spool that is used for one of the first pump passage or the second pump passage.

A maximum diameter of the common spool is greater than a maximum diameter of the normal spool. According to this configuration, the common spool can be made suitable for high flow rates.

The housing may include a first side surface and a second side surface that are parallel to an arrangement plane of the spools, the first side surface and the second side surface facing away from each other. The first pump passage may be located between the first side surface and the spools. The second pump passage may be located between the second side surface and the spools. A distance from the first side surface to the first pump passage may be greater than a distance from the second side surface to the second pump passage. According to this configuration, a space between the first side surface and the first pump passage can be utilized for the installation of another device.

For example, the housing may include a slide hole that is located between the first side surface and the first pump passage and that receives therein another spool different from the spools.

A logic valve that allows a flow from the first pump passage or the second pump passage toward the merging slide hole, but prevents a reverse flow, the logic valve being a valve whose opening degree when allowing the flow from the first pump passage or the second pump passage toward the merging slide hole is changeable, may be located on at least one of the first communication passage or the second communication passage. According to this configuration, the ratio between the flow rate of the hydraulic oil supplied from the first pump passage and the flow rate of the hydraulic oil supplied from the second pump passage when the hydraulic oil supplied from the first pump passage and the hydraulic oil supplied from the second pump passage merge together can be adjusted.

1. A multi-control valve comprising:
spools that are located side by side in a particular direction; and
a housing including slide holes that receive therein the respective spools, the housing including a first pump passage and a second pump passage that extend in the particular direction, the first pump passage and the second pump passage being located at both sides of the spools, respectively, wherein
the spools include a common spool that is used in common for the first pump passage and the second pump passage,
the slide holes include a merging slide hole that receives therein the common spool, and
the housing includes:
a first communication passage that is located at the first pump passage side of the merging slide hole and that extends from the first pump passage to the merging slide hole; and
a second communication passage that is located at the second pump passage side of the merging slide hole and that extends from the second pump passage to the merging slide hole.

2. The multi-control valve according to claim 1, wherein
the housing includes a pair of supply/discharge passages that are located at both sides, respectively, of the first communication passage or the second communication passage,
the common spool includes:
a pair of lands that opens and closes the pair of supply/discharge passages; and
a smaller-diameter portion that couples the pair of lands to each other, and
at least one of the first communication passage or the second communication passage includes:
a bridge passage whose both ends communicate with an annular passage between an inner peripheral surface of the merging slide hole and the smaller-diameter portion; and
a communication hole, through which the first pump passage or the second pump passage communicates with the bridge passage.

3. The multi-control valve according to claim 1, wherein
the housing includes a pair of supply/discharge passages that are located at both sides, respectively, of the first communication passage or the second communication passage, and
the common spool is divided into:
a first spool including a land that opens and closes one of the pair of supply/discharge passages; and
a second spool including a land that opens and closes the other one of the pair of supply/discharge passages.

4. The multi-control valve according to claim 1, wherein
the spools include a normal spool that is used for one of the first pump passage or the second pump passage.

5. The multi-control valve according to claim 4, wherein
a maximum diameter of the common spool is greater than a maximum diameter of the normal spool.

6. The multi-control valve according to claim 1, wherein
the housing includes a first side surface and a second side surface that are parallel to an arrangement plane of the spools, the first side surface and the second side surface facing away from each other,
the first pump passage is located between the first side surface and the spools,
the second pump passage is located between the second side surface and the spools, and
a distance from the first side surface to the first pump passage is greater than a distance from the second side surface to the second pump passage.

7. The multi-control valve according to claim 6, wherein
the housing includes a slide hole that is located between the first side surface and the first pump passage and that receives therein another spool different from the spools.

8. The multi-control valve according to claim 1, wherein
a logic valve that allows a flow from the first pump passage or the second pump passage toward the merging slide hole, but prevents a reverse flow, the logic valve being a valve whose opening degree when allowing the flow from the first pump passage or the second pump passage toward the merging slide hole is changeable, is located on at least one of the first communication passage or the second communication passage.
